(19) United States
(12) Patent Application Publication
(10) Pub. No.: US 2024/0339743 A1
(43) Pub. Date: Oct. 10, 2024

(54) FILTERING DEVICE AND COUPLING STRUCTURE FOR CAVITY FILTERS

(71) Applicant: Samsung Electronics Co., Ltd., Suwon-si (KR)

(72) Inventor: Fanghai XU, Shenzhen (CN)

(21) Appl. No.: 18/743,920

(22) Filed: Jun. 14, 2024

Related U.S. Application Data
(63) Continuation of application No. PCT/KR2022/021093, filed on Dec. 22, 2022.

(30) Foreign Application Priority Data
Dec. 30, 2021 (CN) 202111647712.9

(51) Int. Cl. H01P 1/207; H01P 5/00

(52) U.S. Cl. CPC H01P 1/207; H01P 5/00

(57) ABSTRACT

A filtering device and a coupling structure for cavity filters are provided. The coupling structure includes a first coupling rod, both ends of the first coupling rod being coupled to two adjacent cavity filters, respectively, and a second coupling rod, the second coupling rod being cross-coupled to the first coupling rod, and both ends of the second coupling rod being grounded, so that a resonant frequency of the coupling structure is greater than a resonant frequency of the first coupling rod.

### CROSS-REFERENCE TO RELATED APPLICATION(S)

This application is a continuation application, claiming priority under § 365 (c), of an International application No. PCT/KR2022/021093, filed on Dec. 22, 2022, which is based on and claims the benefit of a Chinese patent application number 202111647712.9, filed on Dec. 30, 2021, in the Chinese Intellectual Property Office, the disclosure of which is incorporated by reference herein in its entirety.

### BACKGROUND

### 1. Field

The disclosure relates to a technical field of communications. More particularly, the disclosure relates to a filtering device and a coupling structure for cavity filters.

### 2. Description of Related Art

With the development of communication technology, base station systems put forward higher and higher index requirements for near-end and far-end suppression of filters. A coupling rod structure is maturely used in a filter to meet the design of high near-end suppression demands, which is an essential component in the filter design. However, the coupling rod structure has a self-resonant frequency, which is determined by a structure size of a coupling rod.

The resonant frequency of the coupling rod, lower than 2 GHZ, is usually higher than the second harmonics of the filter, so that the influence on a passband is not as great. However, as an operating frequency of the filter falls within the range of 3.5-5 GHz and is even higher, the self-resonant frequency of the coupling rod is closer to the passband, resulting in greater near-end suppression of the passband of the filter.

The commonly used method is to improve the suppression deterioration caused by the self-resonance of the coupling rod by increasing a low-pass order, but the most direct influence is to deteriorate an insertion loss of the filter with the increase of the low-pass order. Meanwhile, with the increase of the low-pass order, processing errors will be increased cumulatively, and the influence on the echo performance of the filter will be larger, and this problem will be more serious at high frequency, which will affect the production first-pass yield of the filter and thus affect the production cost of the filter.

However, with regard to the structure of the coupling rod, methods of increasing the range of adjusting a coupling amount of a coupling rod and increasing a structure for achieving negative coupling are mostly used at present, with little effect on solving the problem that the resonant frequency of the coupling rod is close to the passband.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide a filtering device and a coupling structure for cavity filters. A self-resonant frequency of the coupling structure is increased while the amount of coupling is satisfied, so as to widen a distance between the resonant frequency of the coupling structure and a passband of the filtering device.

Additional aspects will be set forth in part in the description which follows and, in part, will be apparent from the description, or may be learned by practice of the presented embodiments.

In accordance with an aspect of the disclosure, a coupling structure for cavity filters is provided. The coupling structure includes a first coupling rod, both ends of the first coupling rod being coupled to two adjacent cavity filters, respectively, and a second coupling rod, the second coupling rod being cross-coupled to the first coupling rod, and both ends of the second coupling rod being grounded, so that a resonant frequency of the coupling structure is greater than a resonant frequency of the first coupling rod.

In an embodiment, the second coupling rod forms a cross coupling in the first coupling rod.

In an embodiment, the first coupling rod includes a first coupling body, and a second coupling portion, the second coupling portion being formed in the middle of the first coupling body, the second coupling portion having a through hole therethrough, and the second coupling rod passing through the through hole and being perpendicular to the first coupling body.

In an embodiment, the resonant frequency of the coupling structure is related to a length of the second coupling rod.

In an embodiment, the second coupling rod is not in contact with an inner wall of the second coupling portion, and the second coupling rod is coaxial with the through hole.

In an embodiment, a cross-sectional shape of the second coupling rod is the same as or different from a shape of the through hole.

In an embodiment, an outer edge of the second coupling portion protrudes from an edge of the first coupling body.

In an embodiment, the first coupling rod includes a first coupling body, ends of the first coupling body extending into one of the cavity filters respectively so as to couple two adjacent cavity filters, and first coupling portions, the first coupling portions extending into the cavity filters from the ends of the first coupling body, and the first coupling portion being parallel to the second coupling rod.

In accordance with another aspect of the disclosure, a filtering device is provided. The filtering device includes a plurality of cavity filters, and a coupling structure including a first coupling rod, both ends of the first coupling rod being coupled to two adjacent cavity filters, respectively, and a second coupling rod, the second coupling rod being cross-coupled to the first coupling rod, and both ends of the second coupling rod being grounded, so that a resonant frequency of the coupling structure is greater than a resonant frequency of the first coupling rod, wherein each cavity filter has a coupling window connected with an adjacent cavity filter, and the coupling structure is mounted to the coupling window to couple two adjacent cavity filters.

Each cavity filter has a coupling window connected with an adjacent cavity filter, and the coupling structure is mounted to the coupling window to couple two adjacent cavity filters.

In an embodiment, each cavity filter includes a metal housing, and a resonator, the resonator being located in the metal housing.

The coupling structure may be coupled to the resonators of two adjacent cavity filters.

Both ends of the second coupling rod may be connected to the metal housing respectively, and the first coupling rod is insulated from the metal housing.

In the embodiment, the cross-coupling structure achieves coupling of two adjacent cavity filters by the first coupling rod, and achieves the purpose of increasing the resonant frequency of the entire coupling structure by the cross-coupling of the second coupling rod and the first coupling rod and the process of both ends of the second coupling rod being grounded. The increase of the resonant frequency of the entire coupling structure, can widen the distance from the resonant frequency of the adjacent cavity filter, so as to reduce the influence of the coupling structure on a passband of a resonant device, thereby improving the near-end suppression of the passband of the resonant device while satisfying a cross-coupling amount.

Compared with a coupling structure including only a first coupling rod, the embodiment, in which the first coupling rod is cross-coupled with a second coupling rod grounded at both ends, increases the resonant frequency of the overall cross-coupling structure.

The increase of the overall resonant frequency of the cross-coupling structure has a better effect on the near-end suppression of the passband of the resonant device than the related methods of adjusting a cross-coupling amount of a coupling rod and increasing a structure for negative coupling. Moreover, the cross-coupling structure of the embodiment can be modified on the basis of the related coupling structure, and the production costs of the cross-coupling structure and the resonant device can be significantly reduced.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a structural schematic view of a coupling structure for cavity filters according to an embodiment of the disclosure;

FIGS. 2A and 2B are top views of a coupling structure for cavity filters according to various embodiments of the disclosure;

FIGS. 3A and 3B are a structural schematic view and an oscillogram of a filtering device according to various embodiments of the disclosure; and

FIGS. 4A and 4B are a structural schematic view and an oscillogram of a comparative example of a filtering device according to various embodiments of the disclosure.

The same reference numerals are used to represent the same elements throughout the drawings.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system, or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

Embodiments of the disclosure provides a filtering device and a coupling structure for cavity filters, which improve the self-resonant frequency of the coupling structure while satisfying the coupling amount, so as to widen the distance between the resonant frequency of the coupling structure and a passband.

It should be appreciated that the blocks in each flowchart and combinations of the flowcharts may be performed by one or more computer programs which include instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g. a central processing unit (CPU)), a communication processor (CP, e.g., a modem), a graphics processing unit (GPU), a neural processing unit (NPU) (e.g., an artificial intelligence (AI) chip), a Wi-Fi chip, a Bluetooth® chip, a global positioning system (GPS) chip, a near field communication (NFC) chip, connectivity chips, a sensor controller, a touch controller, a finger-print sensor controller, a display drive integrated circuit (IC), an audio CODEC chip, a universal serial bus (USB) controller, a camera controller, an image processing IC, a microprocessor unit (MPU), a system on chip (SoC), an integrated circuit (IC), or the like.

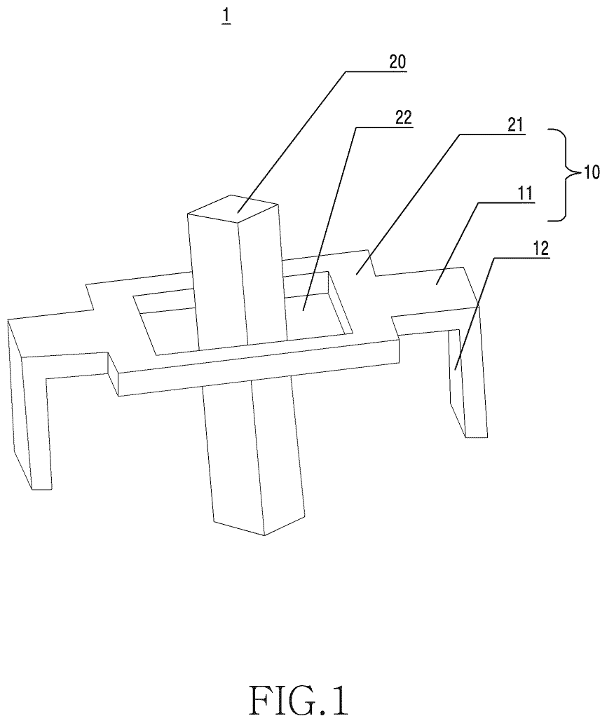

FIG. 1 is a structural schematic view of a coupling structure for cavity filters according to according to an embodiment of the disclosure.

Referring to FIG. 1, an embodiment of the disclosure provides a coupling structure 1 for cavity filters. The coupling structure 1 includes:
a first coupling rod 10, both ends of the first coupling rod 10 being coupled to two adjacent cavity filters 100, respectively;
a second coupling rod 20, the second coupling rod 20 being cross-coupled to the first coupling rod 10, and both ends of the second coupling rod 20 being grounded, so that a resonant frequency of the coupling structure 1 is greater than a resonant frequency of the first coupling rod 10.

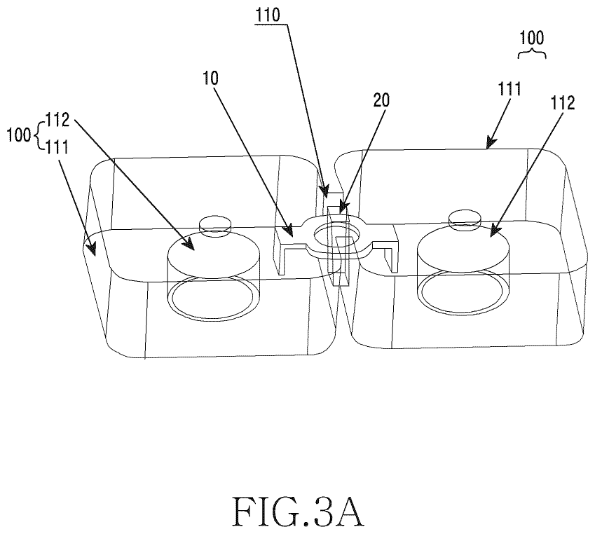

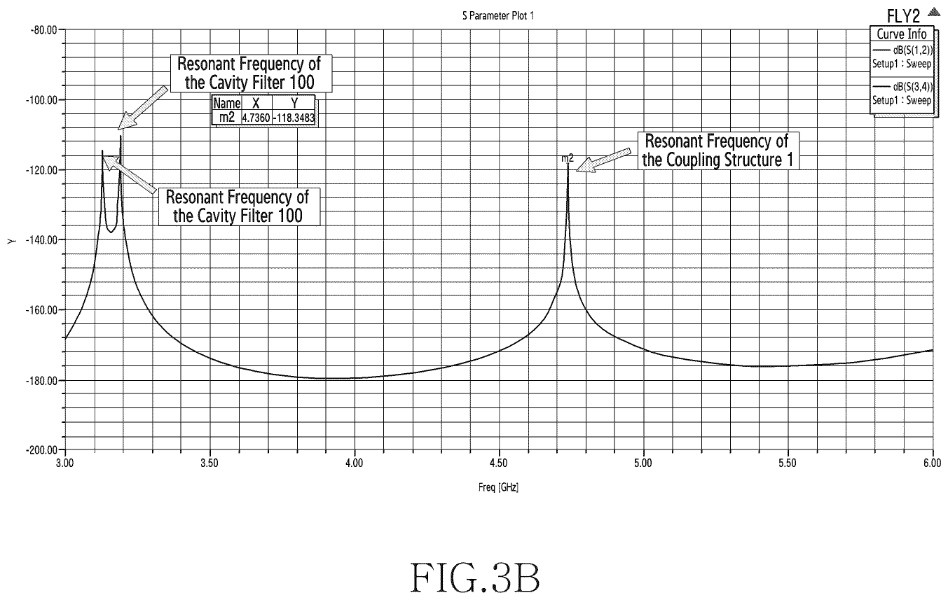

In the embodiment, a cross-coupling structure 1 for cavity filters 100 (shown in FIG. 3A) is provided to form a coupling between adjacent cavity filters and to provide high near-end suppression. A distance between a self-resonant frequency of the coupling structure 1 and a resonant frequency of the adjacent cavity filter 100 determines a near-end suppression effect on a passband of a filtering device.

In the embodiment, the cross-coupling structure achieves coupling of two adjacent cavity filters 100 by the first coupling rod 10, and achieves the purpose of increasing the resonant frequency of the entire coupling structure by the cross-coupling of the second coupling rod 20 and the first coupling rod 10 and the process of both ends of the second coupling rod 20 being grounded. The increase of the resonant frequency of the entire coupling structure 1, can widen the distance from the resonant frequency of the adjacent cavity filter 100, so as to reduce the influence of the coupling structure on a passband of a resonant device, thereby improving the near-end suppression of the passband of the resonant device while satisfying a cross-coupling amount.

Compared with a coupling structure including only a first coupling rod, the embodiment, in which the first coupling rod is cross-coupled to a second coupling rod grounded at both ends, increases the resonant frequency of the overall cross-coupling structure.

The increase of the overall resonant frequency of the cross-coupling structure has a better effect on the near-end suppression of the passband of the resonant device than the related methods of adjusting a cross-coupling amount of a coupling rod and increasing a structure for negative coupling. Moreover, the cross-coupling structure of the embodiment can be modified on the basis of the related coupling structure, and the production costs of the cross-coupling structure and the resonant device can be significantly reduced.

Referring to FIG. 1, the second coupling rod 20 forms a cross coupling in the first coupling rod 10. That is, a cross position of the second coupling rod 20 and the first coupling rod 10 is located inside the first coupling rod 10, rather than outside the first coupling rod 10.

Specifically, the first coupling rod 10 includes:
a first coupling body 11;
a second coupling portion 21, the second coupling portion 21 being formed in the middle of the first coupling body 11, the second coupling portion 21 having a through hole 22 therethrough, and the second coupling rod 20 passing through the through hole 22 and being perpendicular to the first coupling body 11.

In the embodiment, the first coupling body 11 may be formed in the shape of a strip with the through hole 22 at a middle position thereof through which the second coupling rod 20 passes. The second coupling rod 20 is inserted into the through hole 22 without being in contact with the first coupling body 11.

In the case where the first coupling rod 10 extends in a horizontal direction and the second coupling rod 20 extends in a vertical direction, lengths of the second coupling rod 20 above and below the first coupling rod 10 determine the resonant frequency of the coupling structure 1. A cross point of the second coupling rod 20 and the first coupling rod 10 may be located at a midpoint of the second coupling rod 20, or lengths of the second coupling rod 20 above and below the first coupling rod 10 may be different.

The distance between the second coupling rod 20 and an inner wall of the through hole 22 determines a cross-coupling amount of the coupling structure 1. In a preferred embodiment, the second coupling rod 20 is coaxial with the through hole 22, to achieve the same direction and amount in all directions. Of course, the second coupling rod 20 may be non-coaxial with the through hole 22, only maintaining an interval with the first coupling rod 10.

Specifically, a cross-sectional shape of the second coupling rod 20 is the same as or different from a shape of the through hole 22.

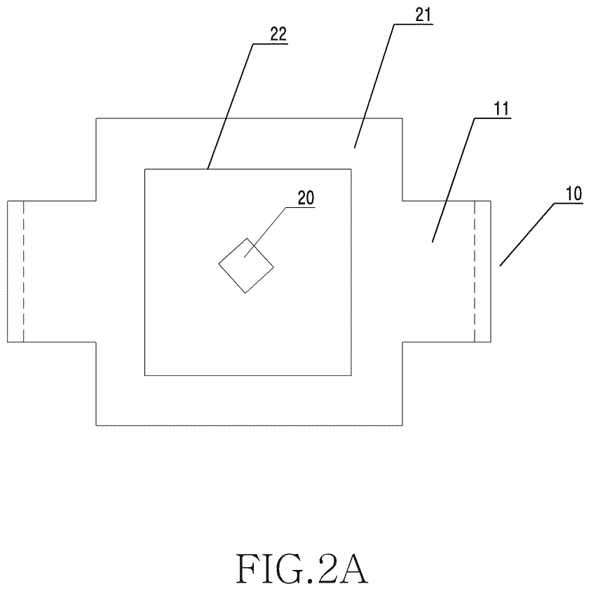

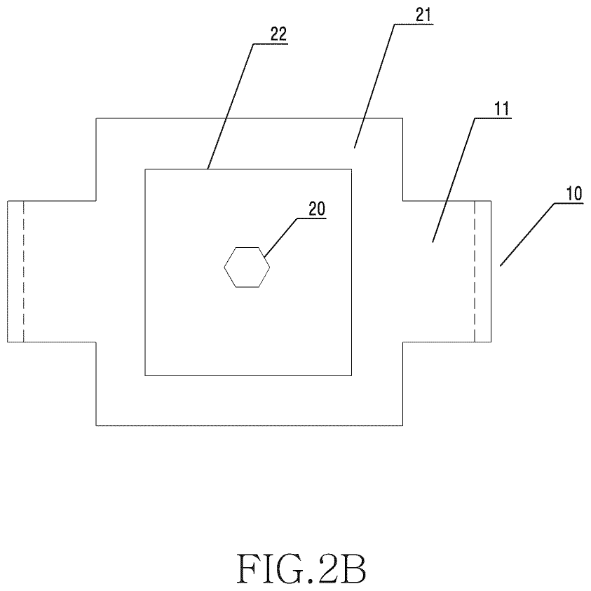

FIGS. 2A and 2B are top views of a coupling structure for cavity filters according to various embodiments of the disclosure.

Referring to FIGS. 1 and 2A, the shape of the through hole 22 is square, and the cross-sectional shape of the second coupling rod 20 is also square. The second coupling rod 20 and the through hole 22 are coaxial, but may have the same or different angular difference. For example, the second coupling rod 20 may be oriented at the same angle as the through hole 22, so that the second coupling rod 20 has the same distance from the first coupling rod 10 in all directions. Referring to FIG. 2A, there is a rotational angle difference, for example, 45°, between an angular orientation of the second coupling rod 20 and an angular orientation of the through hole 22, and the distance between the second coupling rod 20 and the first coupling rod 10 in all directions may be formed to be different, thereby achieving adjustment of the cross-coupling amount of the coupling structure 1.

Referring to FIG. 2B, the shape of the through hole 22 is square, while the cross-sectional shape of the second coupling rod 20 may be circular, hexagonal, triangular or the like. Such arrangement may also be used to achieve adjustment of the cross-coupling amount of the coupling structure 1.

In a specific embodiment, the second coupling portion 21 is formed in the middle of the first coupling body 11, and is integrally formed with the first coupling body 11, mainly for forming the through hole 22 cross-coupled to the second coupling rod 20.

An edge of the second coupling portion 21 may coincide with an edge of the first coupling body 11, that is, the first coupling rod 10 is formed in a straight continuous structure in a lengthwise direction thereof. Alternatively, if an outer edge of the second coupling portion 21 protrudes from the edge of the first coupling body 11, the first coupling rod 10 is formed into a shape in which the middle is thick and both ends are narrow. The second coupling portion 21 protruding from the edge of the first coupling body 11 may form the through hole 22 having a diameter larger than the width of the first coupling body 11 therein, to achieve expansion of an adjustment range for the degree of cross-coupling.

In the embodiment, the adjustment of the cross-coupling amount of the coupling structure 1 can be achieved by adjusting a plurality of factors, such as the size of the second coupling portion 21, the size of the through hole 22, the shape of the through hole 22, the cross-sectional shape of the second coupling rod 20, the distance or angle between the second coupling rod 20 and the first coupling rod 10, and the like, and a larger range of adjustment can be achieved by the combination of the factors, thereby being applicable to a larger range.

Referring to FIG. 1, the first coupling rod 10 includes:
a first coupling body 11, ends of the first coupling body extending into one of the cavity filters 100 respectively, so as to couple two adjacent cavity filters 100;
first coupling portions 12, the first coupling portions 12 extending into the cavity filters 100 from the ends of the first coupling body 11, and the first coupling portions 12 being parallel to the second coupling rod 20.

The length of the first coupling portion 12 may correspond to the coupling amount between the coupling structure 1 and the cavity filters 100. For example, the increase of the length of the first coupling portion 12 may correspond to the increase of the coupling amount.

FIGS. 3A and 3B are a structural schematic view and an oscillogram of a filtering device according to various embodiments of the disclosure.

Referring to FIG. 3A, another embodiment of the disclosure provides a filtering device, including: a plurality of cavity filters 100; and
any one coupling structure 1 as shown in FIGS. 1, 2A, and 2B.

Each cavity filter 100 has a coupling window 110 connected with an adjacent cavity filter 100, and the coupling structure 1 is mounted to the coupling window 110 to couple two adjacent cavity filters 100.

As described above, in the embodiment, the cross-coupling structure achieves coupling of two adjacent cavity filters 100 by the first coupling rod 10, and achieves the purpose of increasing the resonant frequency of the entire coupling structure by the cross-coupling of the second coupling rod 20 and the first coupling rod 10 and the process of both ends of the second coupling rod 20 being grounded. The increase of the resonant frequency of the entire coupling structure 1, can widen the distance from the resonant frequency of the adjacent cavity filter 100, so as to reduce the influence of the coupling structure on a passband of a resonant device, thereby improving the near-end suppression of the passband of the resonant device while satisfying a cross-coupling amount.

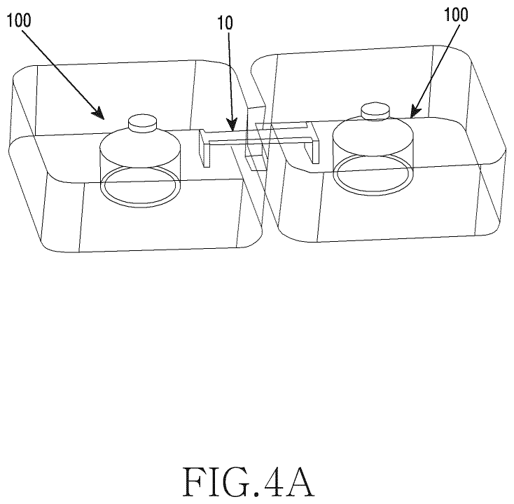

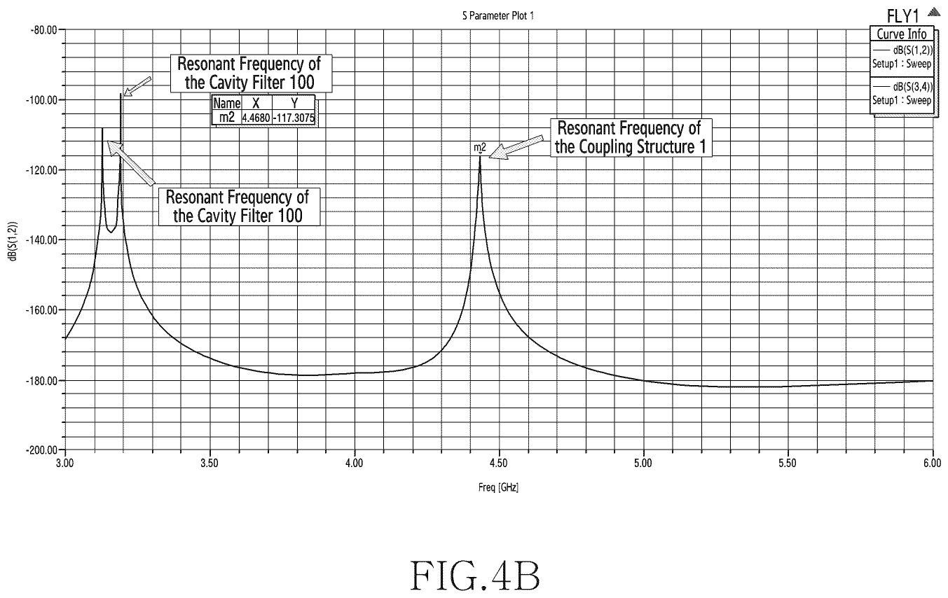

FIGS. 4A and 4B are a structural schematic view and an oscillogram of a comparative example of a filtering device according to various embodiments of the disclosure.

FIG. 4A shows a structural schematic view of a comparative example of a filtering device according to an embodiment of the disclosure.

Referring to FIG. 4A, the filtering device in this comparative example has a cross-coupling structure which forms a cross-coupling with the first coupling rod 10 in the coupling structure 1 shown in FIG. 3A.

Various embodiments shown in FIGS. 3A and 4A employ identical parameters as shown in Table 1.

TABLE 1
Parameter Table of Filtering Device

| | Minimum distance | Width of | Length of | Coupling |
|---|---|---|---|---|
| / | between resonator | the strip | the flanging | coefficient |
| Structure in | 3.5 mm | 6 mm | 4.84 mm | −0.0206 |
| FIG. 4A | | | | |
| Structure in | 3.5 mm | 6 mm | 6.2 mm | −0.0208 |
| FIG. 3A | | | | |

By comparing FIG. 3B with FIG. 4B, it can be seen that the resonant frequency of the coupling structure 1 in the embodiment shown in FIG. 3A is at 4736 MHz, whereas the resonant frequency of the cross-coupling structure in the embodiment shown in FIG. 4A is at 4468 MHz, whereby the resonant frequency of the coupling structure 1 in the embodiment shown in FIG. 3A is increased by 268 MHz.

Specifically, as shown in FIG. 3A, each cavity filter 100 includes:
a metal housing 111; and
a resonator 112, the resonator 112 being located in the metal housing 111.

The coupling structure 1 is coupled to the resonators 112 of two adjacent cavity filters 100.

Both ends of the second coupling rod 20 are connected to the metal housing 111 respectively so as to be grounded, and the first coupling rod 10 is insulated from the metal housing 111.

The metal housings 111 on the surfaces of the adjacent cavity filters 100 are connected from the position of the coupling window 110, and both ends of the second coupling rod 20 may be electrically connected to the metal housings 111 at the position of the coupling window 110. The first coupling rod 10 may be supported at the position of the coupling window 110 by a dielectric support such as plastic to achieve insulation from the metal housing 111.

Thus, the coupling amount of the coupling structure 1 may be further achieved by setting an opening size of the coupling window 110 and then setting the length of the second coupling rod 20.

In the embodiment, the cross-coupling structure achieves coupling of two adjacent cavity filters by the first coupling rod, and achieves the purpose of increasing the resonant frequency of the entire coupling structure by the cross-coupling of the second coupling rod and the first coupling rod and the process of both ends of the second coupling rod being grounded. The increase of the resonant frequency of the entire coupling structure, can widen the distance from the resonant frequency of the adjacent cavity filter, so as to reduce the influence of the coupling structure on a passband of a resonant device, thereby improving the near-end suppression of the passband of the resonant device while satisfying a cross-coupling amount.

Compared with a coupling structure including only a first coupling rod, the embodiment, in which the first coupling rod is cross-coupled to a second coupling rod grounded at both ends, increases the resonant frequency of the overall cross-coupling structure.

The increase of the overall resonant frequency of the cross-coupling structure has a better effect on the near-end suppression of the passband of the resonant device than the related methods of adjusting a cross-coupling amount of a coupling rod and increasing a structure for negative coupling. Moreover, the cross-coupling structure of the embodiment can be modified on the basis of the related coupling structure, and the production costs of the cross-coupling structure and the resonant device can be significantly reduced.

Although the basic principles of the disclosure have been described above in connection with specific embodiments, it should be noted that the merits, advantages, effects, etc. mentioned in the disclosure are merely illustrative and are not restrictive, and these merits, advantages, effects, etc. must be possessed by the various embodiments of the disclosure. In addition, the specific details disclosed above are illustrative and explanatory only and are not restrictive, and the above details do not limit that the disclosure must be realized by the above specific details.

The block diagrams of instruments, devices, equipment, and systems referred to in the disclosure are merely illustrative examples and are not intended to require or imply that the connections, arrangements and configurations must be made in the manner shown in the block diagrams. The instruments, devices, equipment, and systems may be connected, arranged and configured in any manner, as will be appreciated by those skilled in the art. Words such as “including”, “containing” and “having” are open-ended terms that mean “including, but not limited to”, and are used interchangeably therewith. Words “or” and “and” as used herein refer to a word “and/or” and may be used interchangeably therewith unless the context clearly dictates otherwise. A word “such as” as used herein refers to a phrase “such as, but not limited to”, and may be used interchangeably therewith.

It should also be noted that the components or steps may be disassembled and/or recombined in the device, equipment and method of the disclosure. These decompositions and/or recombinations should be considered as equivalents to the disclosure.

The above description of the disclosed aspects is provided to enable any person skilled in the art to make or use the disclosure. Various modifications to these aspects will be readily apparent to those skilled in the art, and the general principles defined herein may be applied to other aspects without departing from the scope of the disclosure. Therefore, the disclosure is not intended to be limited to the aspects shown herein, but in accordance with the widest scope consistent with the principles and novel features disclosed herein.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. A coupling structure for cavity filters, the coupling structure comprising:
a first coupling rod, both ends of the first coupling rod being coupled to two adjacent cavity filters, respectively; and
a second coupling rod, the second coupling rod being cross-coupled to the first coupling rod, and both ends of the second coupling rod being grounded, so that a resonant frequency of the coupling structure is greater than a resonant frequency of the first coupling rod.

2. The coupling structure according to claim 1, wherein the second coupling rod forms a cross coupling in the first coupling rod.

3. The coupling structure according to claim 2, wherein the first coupling rod comprises:
a first coupling body; and
a second coupling portion, the second coupling portion being formed in the middle of the first coupling body, the second coupling portion having a through hole therethrough, and the second coupling rod passing through the through hole and being perpendicular to the first coupling body.

4. The coupling structure according to claim 1, wherein the resonant frequency of the coupling structure is related to a length of the second coupling rod.

5. The coupling structure according to claim 3, wherein the second coupling rod is not in contact with an inner wall of the second coupling portion and the second coupling rod is coaxial with the through hole.

6. The coupling structure according to claim 3, wherein a cross-sectional shape of the second coupling rod is the same as or different from a shape of the through hole.

7. The coupling structure according to claim 3, wherein an outer edge of the second coupling portion protrudes from an edge of the first coupling body.

8. The coupling structure according to claim 3, wherein the first coupling rod comprises:
a first coupling body, ends of the first coupling body extending into one of the cavity filters respectively so as to couple two adjacent cavity filters; and
first coupling portions, the first coupling portions extending into the cavity filters from the ends of the first coupling body, and the first coupling portions being parallel to the second coupling rod.

9. A filtering device, comprising:
a plurality of cavity filters; and
a coupling structure including:
a first coupling rod, both ends of the first coupling rod being coupled to two adjacent cavity filters, respectively, and
a second coupling rod, the second coupling rod being cross-coupled to the first coupling rod, and both ends of the second coupling rod being grounded, so that a resonant frequency of the coupling structure is greater than a resonant frequency of the first coupling rod,
wherein each cavity filter has a coupling window connected with an adjacent cavity filter, and the coupling structure is mounted to the coupling window to couple two adjacent cavity filters.

10. The filtering device according to claim 9, wherein each of the plurality of cavity filters comprises:
a metal housing; and
a resonator, the resonator being located in the metal housing,
wherein the coupling structure is coupled to resonators of two adjacent cavity filters,
wherein both ends of the second coupling rod are connected to the metal housing respectively, and
wherein the first coupling rod is insulated from the metal housing.
